(19) United States
(12) Patent Application Publication
(10) Pub. No.: US 2007/0239090 A1
(43) Pub. Date: Oct. 11, 2007

(54) Massage System

(75) Inventor: Iulian Mitea, Windsor (CA)

Correspondence Address: HUSCH & EPPENBERGER, LLC, 190 CARONDELET PLAZA, SUITE 600, ST. LOUIS, MO, 63105-3441, US

(73) Assignee: SCHUKRA OF NORTH AMERICA, Tecsumeh (CA)

(21) Appl. No.: 11/695,398

(22) Filed: Apr. 2, 2007

Related U.S. Application Data
(60) Provisional application No. 60/787,853, filed on Mar. 31, 2006.

(51) Int. Cl. A61H 7/00

(52) U.S. Cl. 601/112; 601/98; 601/101; 601/103

(57) ABSTRACT

A rotary massaging system for a vehicle seat comprises a rectangular frame having a carriage mechanism slideably disposed therein for travel between ends of the frame; a adjustment unit for adjusting the position of the carriage mechanism within the rectangular frame; and a massage unit mounted on the carriage mechanism.

### CROSS-REFERENCE TO RELATED APPLICATIONS

This application claims priority to U.S. Provisional Patent Application No. 60/787,853 filed Mar. 31, 2006.

### BACKGROUND OF THE INVENTION

1. Field of the Invention

The present invention relates to massage systems, in particular a massage system that can be used in seats.

2. Related Art

Seat comfort systems, such as massage systems in the automotive and aerospace industries, are an increasingly popular option. It is advantageous to decrease the cost of installing such systems while still providing a high quality massage with active massaging components.

### SUMMARY OF THE INVENTION

One aspect of the invention is a rotary massaging system for a vehicle seat comprising a frame having a carriage mechanism slideably disposed therein for travel between ends of the frame; a adjustment unit for adjusting the position of the carriage mechanism within the frame; and a massage unit mounted on the carriage mechanism. The massage unit comprises a drive unit; a gear box operably coupled to the drive unit; a first plurality of massaging fingers rotatably attached to a first rotary arm and coupled to the drive unit by the gear box; and a second plurality of massaging fingers rotatably attached to a second rotary arm and coupled to the drive unit by the gear box.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a perspective view of a vehicle seat with an embodiment of a massage system installed therein;

FIG. 2 shows a perspective view of an embodiment of a massage system in both a raised and lowered state in a frame;

FIG. 3 shows a perspective view of an embodiment of seat support material along with two belt-style lumbar supports associated therewith;

FIG. 4 shows detailed views of the rotary massaging unit that travels along the carriage;

FIG. 5 shows detailed views of the actuator system that moves the carriage vertically, i.e. the up-down actuator; and

FIG. 6 shows detailed views of the carriage mechanism.

FIG. 7 shows a perspective view of an embodiment of a massage system in both a raised and lowered state in a frame.

FIG. 8 shows a detailed perspective view of an embodiment of a massage system.

FIG. 9 shows a schematic of the forces involved in a constant pressure apparatus used in connection with a massage system.

FIG. 10 shows a detailed perspective view of an embodiment of a massage system installed in a frame.

FIG. 11 shows a perspective view of an embodiment of a massage system installed in a frame.

FIG. 12 shows a detailed perspective view of an embodiment of a massage system installed in a frame.

### DETAILED DESCRIPTION OF THE PREFERRED EMBODIMENTS

The following description of the preferred embodiment(s) is merely exemplary in nature and is in no way intended to limit the invention, its application, or uses.

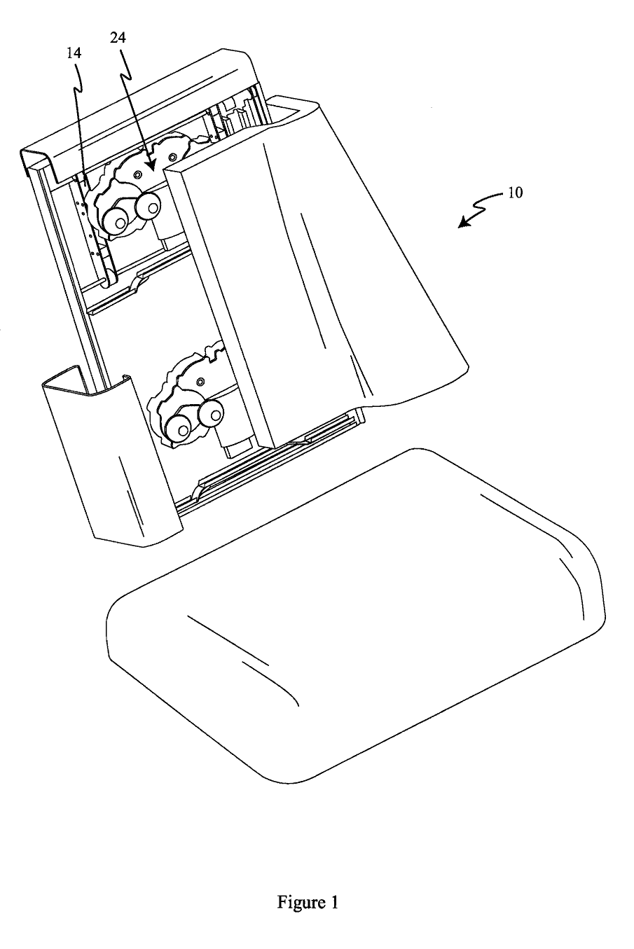

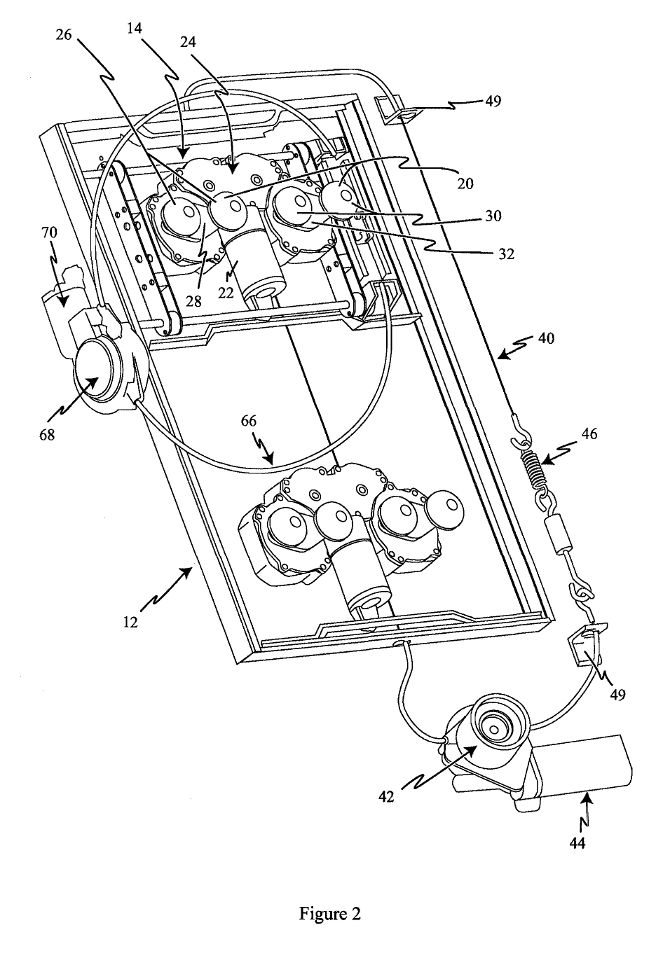

An embodiment of a seat back 10 shown in FIGS. 1-2 and 4-6 having a comfort system comprising a rectangular frame 12, a carriage 14 slideably disposed in the rectangular frame 12, a vertical adjustment system for adjusting the vertical position of the carriage mechanism, and two massage units 20 mounted on the carriage 14. Preferably, the seat back 10 is a vehicle seat, namely car, truck, bus, boat or airplane seat back, although use as an office chair is also possible.

The massage unit 20 comprises a drive unit 22, a gear box 24, a first plurality of massage fingers 26 attached to a first rotary arm 28, and a second plurality of massage fingers 30 attached to a second rotary arm 32. The gear box 24 transfers power from the drive unit 22 to both the first and second rotary arms 28, 32, causing both rotary arms 28, 32 to rotate. In an embodiment of the invention, the drive unit 22 is shown as an electric motor and the first arm 28 rotates in a direction opposite to the direction of the second rotary arm 32. By way of example, when the first rotary arm 28 in this embodiment rotates clockwise, the second rotary arm 32 rotates counterclockwise. It is within the scope of this invention that a control could be included that would allow the user of the vehicle seat back 10 to choose the direction of rotation of the rotary arms 28, 32.

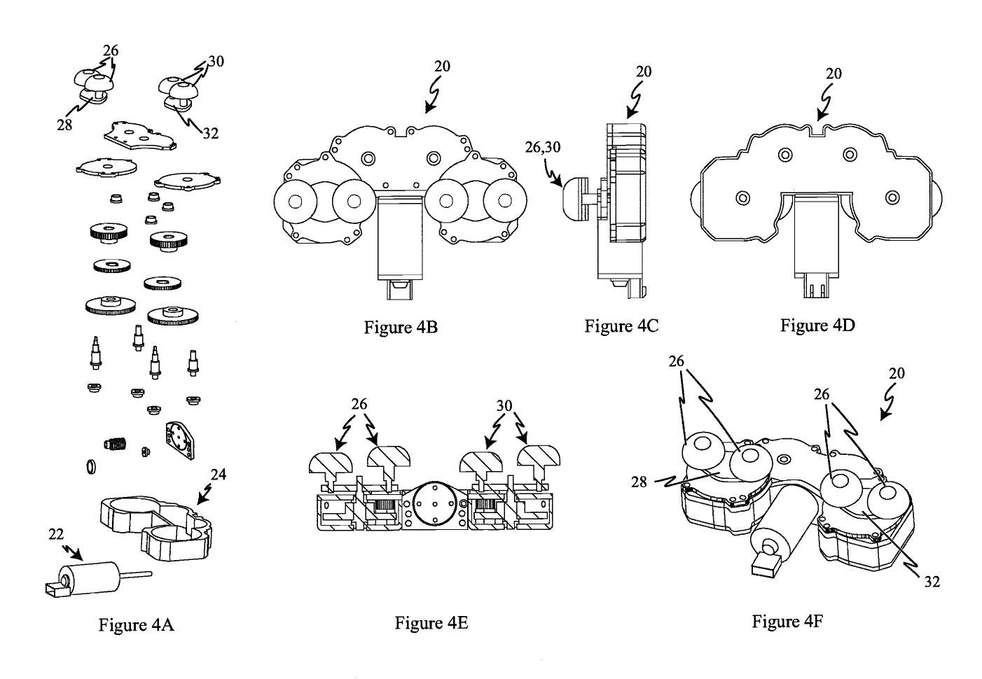

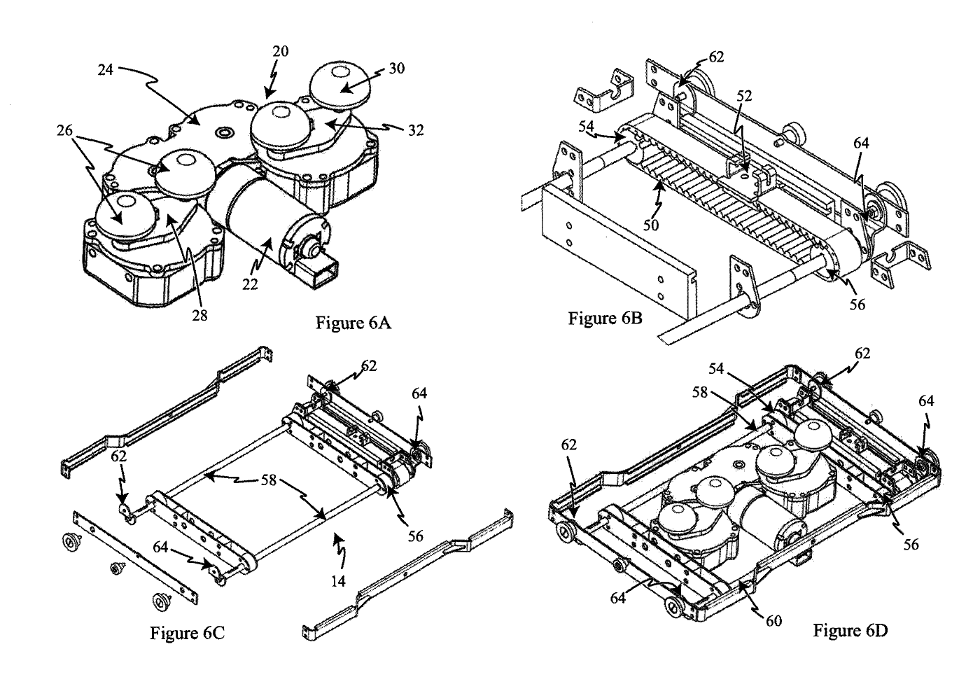

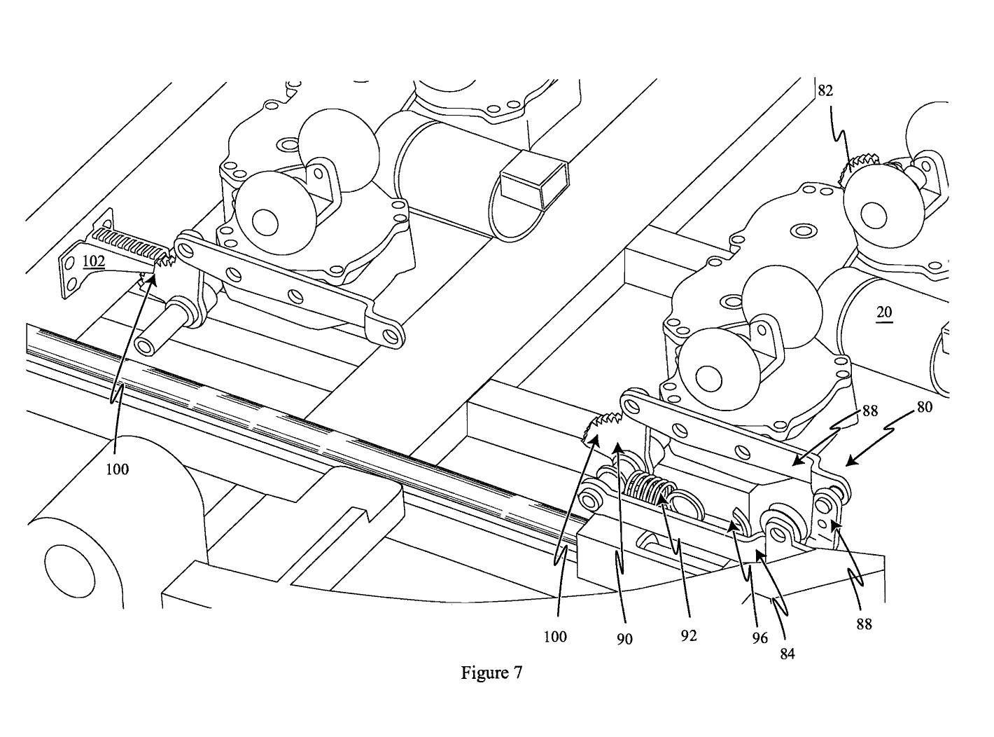

In some embodiments of the invention the massage fingers 26, 30 are rollers (best seen in FIGS. 7, 8, 11 and 12) that rotate freely at the ends of the rotation arms 28, 32 in a plane perpendicular to a plane of a seat back 10. In an alternate embodiment, the massage fingers 26, 30 are rounded, hemispherical knobs (best seen in FIGS. 4 and 6) that rotate freely at the ends of rotation arms 28, 32 in a plane parallel to a seat back 10. The massage fingers 26, 30 may be mounted at varying elevations relative to the rotation arms 28, 32, with each arm preferably having a lower finger and a higher finger.

The massage unit 20 is attached to the carriage 14, which is slideably mounted in the rectangular frame 12. In a preferred embodiment, the rectangular frame 12 is disposed within the back portion of the vehicle seat 10. In alternate embodiments the rectangular frame 12 may be mounted in a seat for home use, in a bed, or in a freestanding pad.

The carriage 14 is mounted within the rectangular frame 12 such that it may move up-and-down. In an embodiment of the invention, a first end of a vertical adjustment cable 40 is attached to an upper end of the carriage 14 and a second end of the vertical adjustment cable 40 is attached to a lower end of the carriage 14. The ends of the vertical adjustment cable 40 may be attached to the ends of the carriage 14 directly, or by a pulley 42 (FIG. 1) attached to the carriage 14. A middle portion of the vertical adjustment cable 40 is wrapped one time around a vertical adjustment pulley 42 that is driven by a vertical adjustment actuator 44. The vertical adjustment pulley 42 utilizes a rubber surface to increase friction between the pulley 42 and cable 40. The rubber will also act as a friction clutch and permit slippage in case the carriage 14 stalls. As the actuator 44 turns, the carriage 14 slides up or down within the rectangular frame 12 depending on the direction of the actuator's 44 movement. The vertical adjustment cable 40 is preferably a cable and conduit system, commonly known as a Bowden cable, wherein a cable 40 is disposed within a relatively non-compressible yet flexible conduit 48 and slides in an axial direction within the conduit 48. This cable 40 and conduit 48 system allows power to be transferred along a non-linear path.

The maximum vertical travel range of the carriage 14 is preferably 330 mm. When the vertical adjustment actuator 44 is a 4-turn actuator, the vertical adjustment cable 40 is wrapped one turn around the actuator's pulley 42.

A spring 46 is disposed in a midsection of the cable 40 to maintain tension on the cable 40. In addition, the spring 46 will help cushion movements of the cable 44, thereby smoothing out movements of the carriage 14 and reducing wear on the actuator 44. To facilitate a spring 46 to be disposed in the midsection of the cable 44, the conduit may be interrupted at various points and supported by brackets 49, with the axial cable 44 stretched therebetween.

The depth of the massage unit with respect to the back of the seat 10 may be varied by moving the massage unit 20 in and out, i.e. in a direction perpendicular to the rectangular frame 12, in order to adjust the intensity of the massage.

In another embodiment of the invention (shown in FIG. 6), in and out movement of the massage unit 20 is controlled by a depth-adjustment system comprising a belt 50, which is preferably made of rubber; a bracket 52 fixed to the belt 50; first and second rollers 54, 56 engaged with the belt 50; first and second rods 58, 60 coupled to the rollers 54, 56; first and second pairs of oblong rotation brackets 62, 64 are attached to the end of the rods 58, 60; a depth adjustment cable 66; a depth adjustment pulley 68, which is similar to the vertical adjustment pulley 42; and a depth adjustment actuator 70. The depth adjustment actuator 70 is preferably an actuator enabled with some type of memory function. The in and out movement adjusts the intensity of the massage. Outward movement increases the massage intensity whereas inward movement decreases massage intensity or ceases the massage altogether.

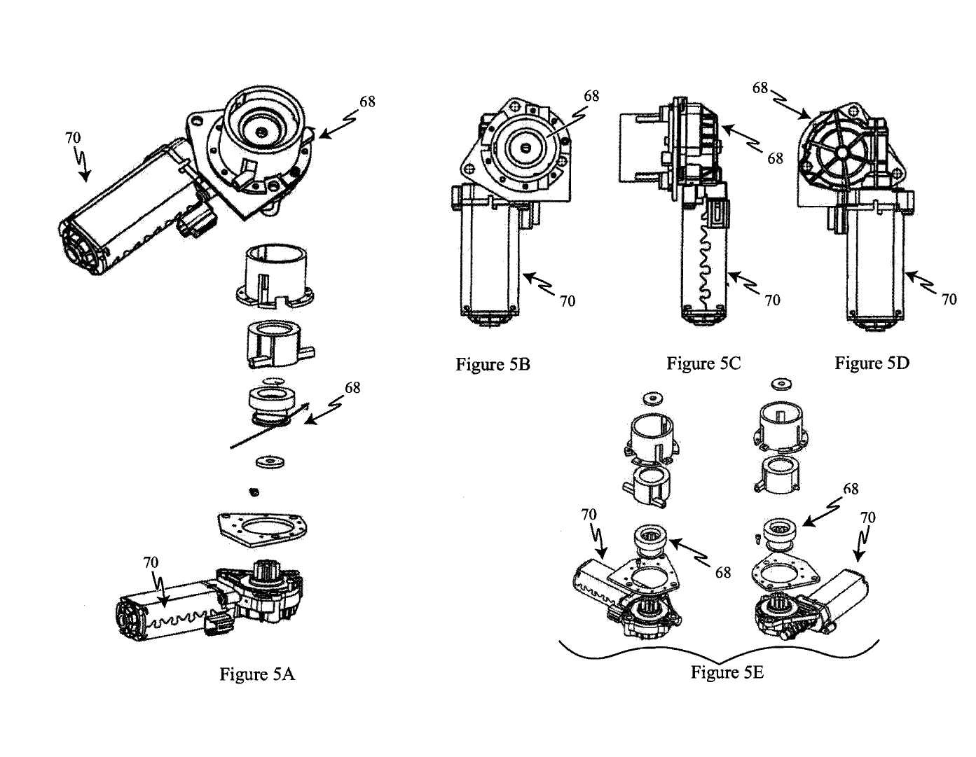

According to FIG. 5 the depth adjustment actuator 70 is an electric motor as shown and is mounted on the side of the rectangular frame 12, preferably near the center. The depth adjustment cable 66 wraps around the depth adjustment pulley 68 one time and is moved as the pulley 68 turns. The depth adjustment pulley 68 is driven by the depth adjustment actuator 70. The two ends of the depth adjustment cable 66 anchor to the bracket 52, which is fixed to a belt 50 (FIG. 6). Preferably the belt 50 is toothed on the inside and the teeth of the belt engage with complementary teeth on the first and second rollers 54, 56 around which the belt 50 is wrapped. As seen in FIG. 6, when the belt 50 is moved by the depth adjustment cable 66, the belt 50 rotates the rollers 54, 56, which causes the rods 58, 60 to also turn. Accordingly, the pairs of oblong rotation brackets 62, 64 attached to the end of the rods 58, 60 turn as the rods 58, 60 turn. The pairs of rotation brackets 62, 64 are rotatably attached to the side portions of the rectangular frame 12.

Thus, when the pairs of rotation brackets 62, 64 turn, the rods 58, 60 are displaced in a circular motion relative to the rectangular frame 12. The massage unit 20 is rotably connected to both the first and second rods 58, 60, thus the massage unit 20 is displaced as well, in and out of the seat occupant's back. As used herein, “in” and “inward” indicate the direction away from a seat occupants back and “out” and “outward” indicate the direction towards a seat occupants back. Since the massage unit 20 is attached to both rods 58, 60, via the carriage 14, the massage unit 20 remains parallel to the plane of the rectangular frame 12 throughout the range of motion of the rods 58, 60. Preferably the rods 58, 60 do not go through a full range of motion but only to rotate a half turn, from the point where the rods 58, 60 are in the furthest out position to the furthest in position. The range of travel of the rods 58, 60 is limited by the range of the belt 50, which is determined by how far the bracket 52 will move before hitting a second set of brackets at which a conduit, through which the depth adjustment cable 66 runs, terminates on either side of the belt.

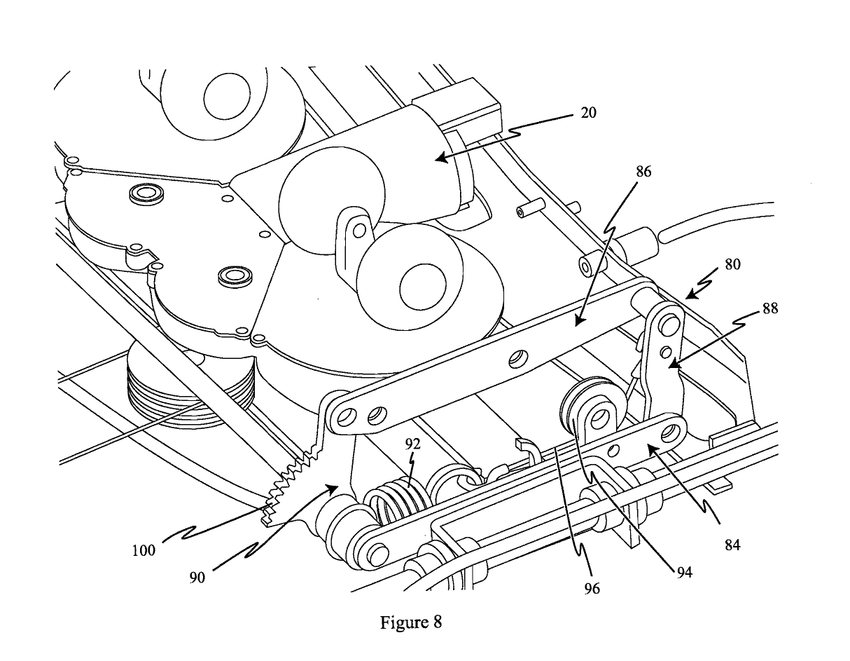

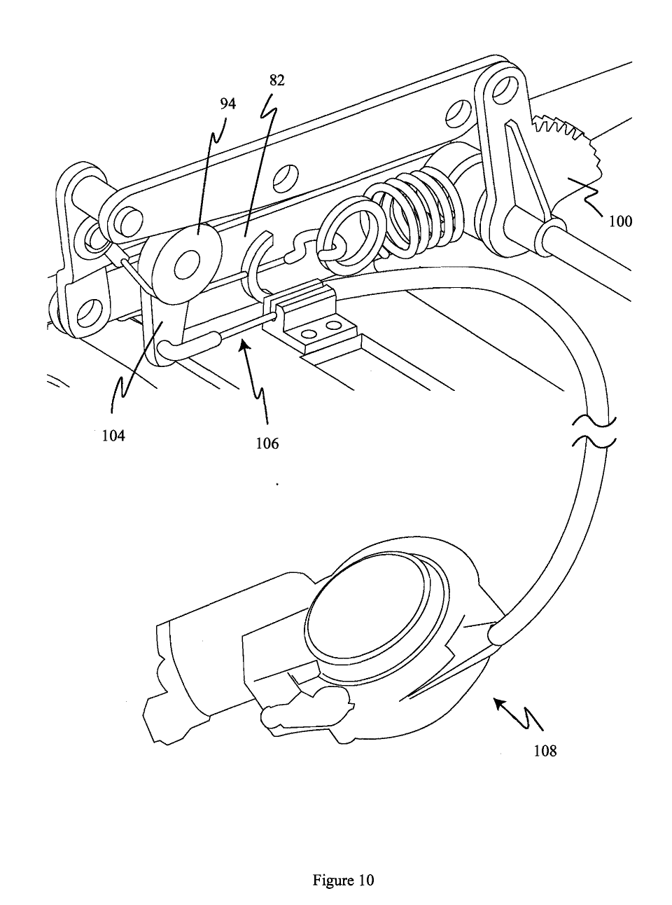

In another embodiment of the invention shown in FIGS. 7-10, a first and second constant force apparatus 80, 82 cause a constant force to be applied by the massage unit 20 for a range of in and out movement of the massage unit 20. The constant force apparatuses 80, 82 respectively comprise a substantially parallel inner and outer bar 84, 86; a substantially parallel upper and lower bar 88, 90, a spring 92, a pulley 94 and a cable 96. The inner, outer, upper and lower bars 84, 86, 88, 90 are hingedly connected so as to form a parallelogram that does not have fixed angles between the four sides. The arrangement of these components is shown in FIGS. 7 and 8. As seen in these FIGS., a first end of the spring 92 is fixed relative to the joint connecting the lower bar 90 and the inner bar 84. A second end of the spring 92 is attached to a first end of the cable 96.

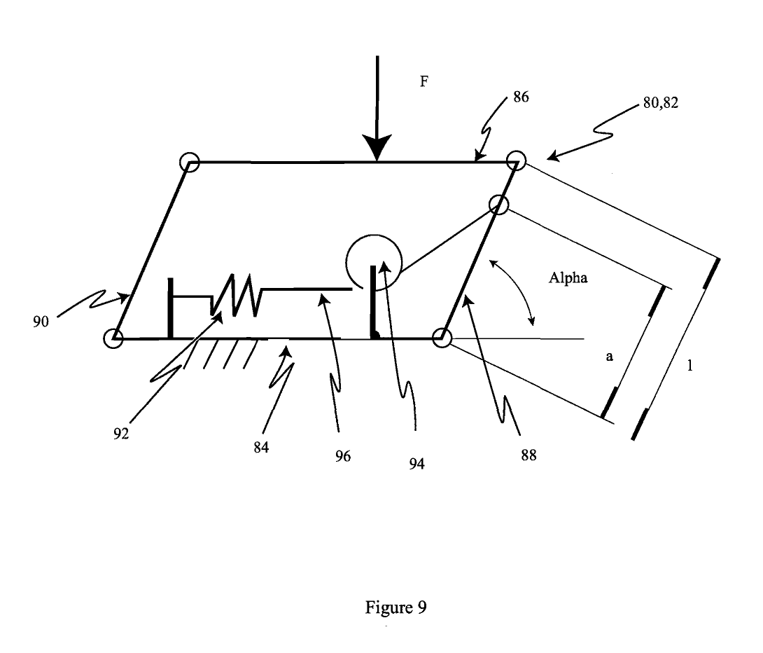

The cable 96 changes direction at the pulley 94 as shown in FIGS. 8 and 9. A second end of the cable 96 is attached to the upper bar 88 at a point between the inner bar 84 and the outer bar 86.

A first constant force apparatus 80 is slideably connected to the right portion of the rectangular frame 12 and fixed to the right portion of the carriage 14. A second constant force apparatus 82 is slideably connected to the left portion of the rectangular frame 12 and fixed to the left portion of the carriage 14. When a force is applied to the massage fingers 26, 30, that force is transferred, in turn, to the massage unit 20, the carriage 14, and then the respective outer bars 86 of the first and second constant force apparatuses 80, 82. As shown schematically in FIG. 9, the applied force causes the constant force apparatuses 80, 82 to flatten, i.e. the inner and outer bars 84, 86 come closer together, which allows the massage unit 20 to move in a direction away from the back of the occupant of the seat. Furthermore, due to the configuration of the spring 92, pulley 94 and cable 96, the force applied by the outer bar 86 against the massage unit 20 remains constant despite the flattening of the constant force apparatuses 80, 82. This is represented mathematically as K=F1/ab for any alpha. This allows the massage unit 20 to provide a constant force against the back of the occupant while conforming to the contours of his or her back.

Furthermore, as best seen in FIGS. 7, 8 and 10, a first pair of gears 100 is provided fixed to the respective lower bars 90 of both constant force apparatuses 80, 82, and a second pair of gears 102 is provided fixed to the lower portion of the rectangular frame 12. The first and second pairs of gears 100, 102 are disposed such that both pairs of gears 100, 102 engage when the carriage 14 approaches a full down position, i.e. the carriage 14 is near the lower portion of the rectangular frame 12. As the first and second pairs of gears 100, 102 engage and the carriage 14 moves towards the full down position, the second pair of gears 102 forces the rotation of the first pair of gears 100, and, accordingly, the rotation of both lower bars 90. The rotation of the lower bars 90 causes the outer bars 86 to translate in a generally upward and inward direction. The result is a flattening of the constant force apparatuses 80, 82, and, therefore, an inward movement of the massage unit 20. Thus, a “home” position is provided without the need for an additional actuator.

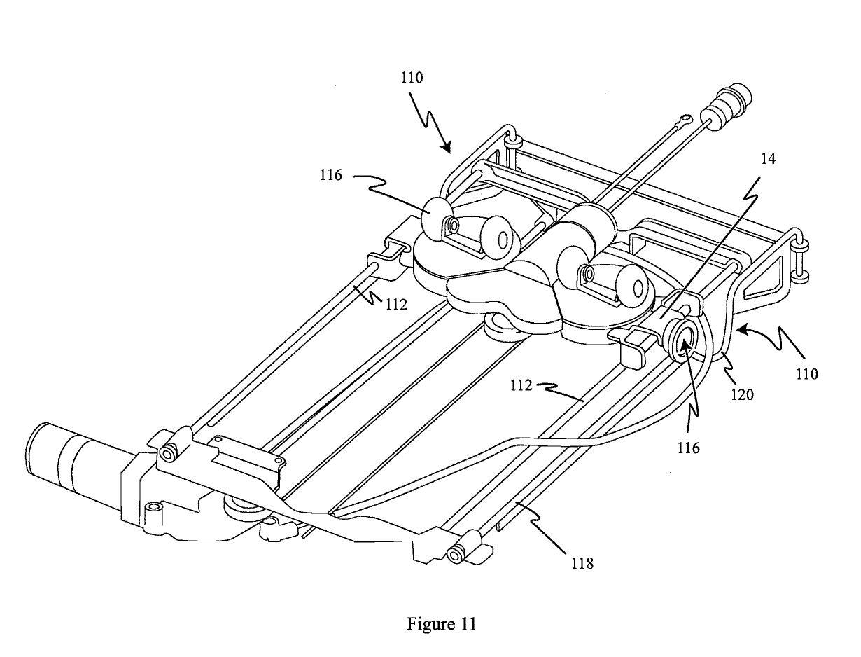

In another embodiment of the invention shown in FIG. 11, the constant force apparatus discussed in the previously disclosed embodiment (FIGS. 7-10) is modified so as to allow the constant force applied by the outer bar 86 to be adjusted. This is accomplished by attaching the pulley 94 of each constant force apparatus, respectively, to a first end of a lever 104. The lever 104 rotates about a mid-point that is rotably connected to the inner bar 82. A second end of the lever 104 is attached to a first end of a tension cable 106, such as a Bowden cable. The tension cables 106 connected to levers 104 of both the first and second constant force apparatuses 80, 82 are in operative communication with a single actuator 108 that drives both cables 106. The actuator 108 can increase or decrease the force applied to the cables 106 and thereby change the position of the pulley 94. By varying the position of the pulley 94, the amount of constant force that will be provided by the outer bar 86, and ultimately felt by the occupant of the seat, is adjusted.

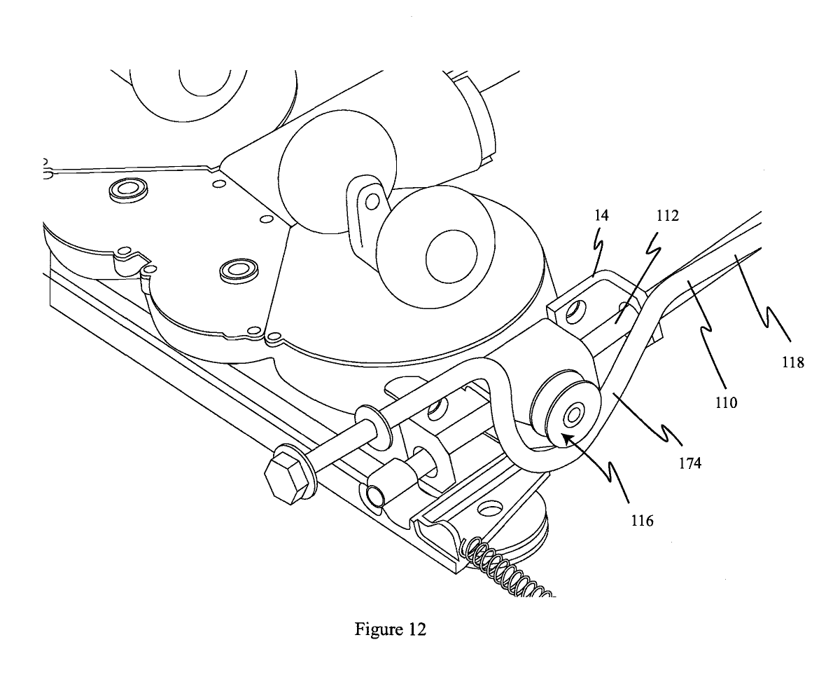

Further shown in FIGS. 11 and 12, the carriage 14 is guided by two pairs of guide rails, up and down guide rails 110 and in and out guide rails 112. The carriage 14 is slideably connected to the up and down guide rails 100, which are substantially straight. The up and down guide rails 110 provide the left and right portions of the rectangular frame 12, and the lower ends of the up and down guide rails 110 are rigidly connected to the lower portion of the rectangular frame 12. The lower portion of the rectangular frame 12 is connected to a pair of springs 114, which exert a force on the lower portion of the rectangular frame 12 and tend to pull the lower portion of the rectangular frame 12 inward, i.e. away from the back of an occupant of the seat. The upper ends of the up and down guide rails 110 are hingedly connected to the upper portion of the rectangular frame 12, thus allowing the carriage 14, the up and down guide rails 110 and the lower portion of the rectangular frame 12 to pivot about the upper portion of the rectangular frame 12.

Furthermore, the carriage 14 is attached to a plurality of rollers 116 that freely roll on the in and out guide rails 112. The rollers 116 roll on the outward portion of the in and out guide rails 112. Thus, in operation the in and out guide rails 112 limit various items (namely, the carriage 14, the up and down guide rails 10, and lower portion of the rectangular frame 12) from pivoting under the force of the springs 114. Accordingly, the force exerted by the springs 114 ensures continual contact between the rollers 116 and the in and out guide rails 112. The in and out guides rails 112 are preferably comprised of a substantially straight portion 118 near the upper part of the rectangular frame 12 and a depressed portion 120 near the bottom of the rectangular frame 12. The substantially straight portion 118 is preferably significantly longer than the depressed portion 120.

In operation, as the carriage 14 is drawn downward, the rollers 116 reach the depressed portion 120, at which point the rollers 116 roll inward, i.e. away from the back of the occupant of the seat, and accordingly the carriage 14 and the attached massage unit 20 pivot inward due to the force exerted by the springs 114 on the lower portion of the rectangular frame 12. When the carriage 14 is in the depressed region 120 and near the lower portion of the rectangular frame 12, preferably the system is considered to be in a “home” position, and when the massage unit 20 is not in use, the massage unit 20 is returned to the “home” position.

Each of the massage functions can be user-controllable. Therefore, the user may control the direction of the rotation of the massage fingers 26, 30, the intensity of the massage, and the location of the massage. The up-and-down motion of the massage may also be automated such that the massage fingers travel up and down the seat occupant's back as desired.

A lumbar support for a seat having the described massage system is also encompassed within this disclosure. The lumbar support can work dynamically in tandem with the rotary massagers to provide additional comfort.

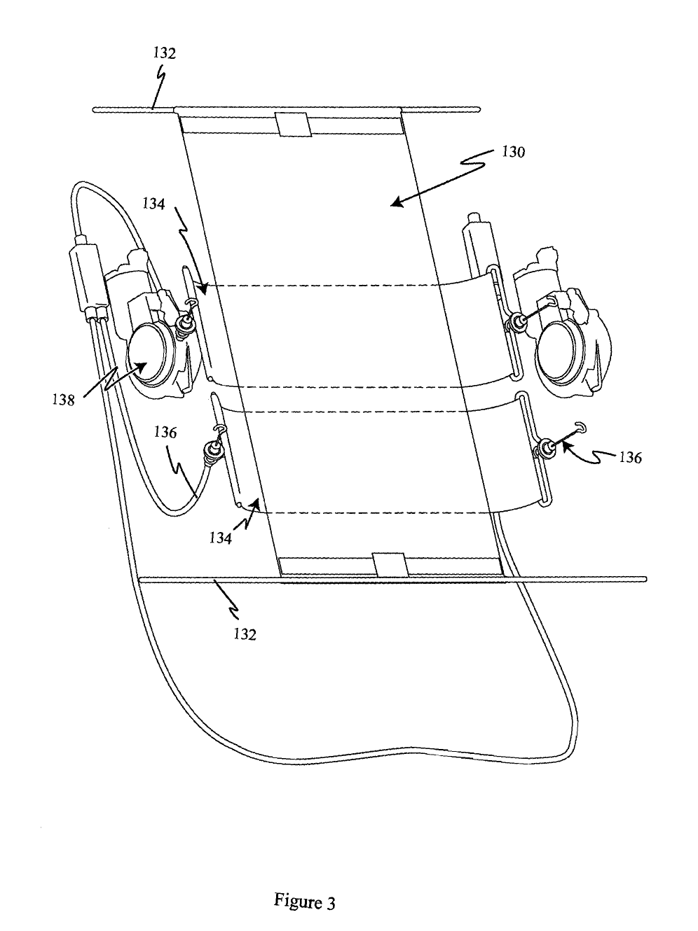

In the embodiment of the invention shown in FIG. 3 a layer of flexible seat support material 130 is preferably placed on top of the massage unit 20 such that the support material 130 is disposed between the massage unit 20 and the backside of the seat cushion foam. The flexible seat support material 130 may be comprised of SYTEX brand material. The flexible seat support material 130 provides basic support for the seat occupant plus it has the added benefit of protecting the seat foam from pressure and friction related degradation due to the movement of the massage unit 20 because it reduces friction.

In one embodiment a sheet of flexible seat support material 130 is stretched vertically and attached to the seat frame at the top and bottom using horizontally disposed rods 132 that are attached to the seat frame via springs. According to this embodiment one or more horizontal pieces 134 of similar material are suspended, on either side of the vertical sheet, to create a belt-style lumbar support. Specifically, the horizontal pieces 134 are attached to tension cables 136 which are operatively connected to an actuator 138. The actuator 138 can flex and relax the horizontal pieces 134 to provide additional massaging action through repeated movements of the belt lumbars.

In operation of an embodiment of the invention the seat occupant can select a “Full Back Massage”, wherein the carriage 14 moves through its full range of travel in the vertical direction; a “Lower Back massage”, wherein the carriage 14 moves in the vertical direction only in the region of the lower back; a “Shoulder Massage”, wherein the carriage 14 moves in the vertical direction only in the region of the upper back; “Middle Back Massage”, wherein the vertical movement of the carriage 14 is limited to the middle back area; and “Custom Massage”, wherein the occupant manually positions the carriage 14 in the vertical direction to receive a local massage.

Other user-selectable features include reversal of the direction of movement of the rotation arms 28, 32, adjustment of the vertical speed of the carriage 14, and the in and out position can be memorized or saved.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A rotary massaging system for a seat, comprising:
a frame having a carriage mechanism slideably disposed therein for travel between ends of the frame;
an adjustment unit for adjusting the position of the carriage mechanism within the frame; and
a massage unit mounted on the carriage mechanism, the massage unit comprising:
a drive unit;
a gear box operably coupled to the drive unit;
a first plurality of massaging fingers rotatably attached to a first rotary arm and coupled to the drive unit by the gear box; and
a second plurality of rounded massaging fingers rotatably attached to a second rotary arm and coupled to the drive unit by the gear box.

2. The rotary massaging system of claim 1 wherein the first plurality of massaging fingers rotates clockwise and the second plurality of massaging fingers rotates counter-clockwise.

3. The rotary massaging system of claim 1 wherein the adjustment unit comprises:
a traction cable having a first end attached to an upper portion of the carriage mechanism and a second end attached to a lower portion of the carriage mechanism;
a pulley, wherein a first middle portion of the traction cable is wrapped around the pulley, coupled to the drive unit.

4. The rotary massaging system of claim 3 further comprising a spring interposed between a first and second section of the traction cable.

5. The rotary massaging system of claim 1 further comprising an in-out adjustment mechanism for adjusting the position of the massaging fingers.

6. The rotary massaging system of claim 5 wherein the in-out adjustment mechanism comprises:
a belt;
a securing bracket fixed to the belt;
an actuator;
a tension wire having a first end fixed to the securing bracket and a second end in operative communication with the actuator;
a first and second roller rotably engaged with the belt;
a first rod coupled to the first roller and a second rod coupled to the second roller, wherein the position of the carriage mechanism is determined by the position of the first and second rod;
a first pair of rotation brackets coupled to the first rod and rotably attached to the frame; and
a second pair of rotation brackets coupled to the second rod and rotably attached to the frame;
wherein the rotation of the first and second pairs of rotation brackets displace the first and second rod, respectively, in a circular motion.

7. The rotary massaging system of claim 1 further comprising a constant force apparatus providing a constant force in the outward direction while facilitating movement of the carriage mechanism in an inward and outward direction.

8. The rotary massaging system of claim 7 wherein the constant force apparatus comprises:
an inner and outer bar;
an upper and lower bar, wherein the inner, outer, upper and lower bar are hingedly connected;
a spring having a first and second end, wherein the first end is fixed relative to the hinged connection of the lower bar and the inner bar;
a cable having a first and second end, wherein the first end of the cable is attached to the second end of the spring;
a pulley, wherein the cable changes direction at the pulley;
wherein the second end of the cable is attached to the upper bar at a point between the inner bar and the outer bar.

9. The rotary massaging system of claim 8 wherein the inner and outer bar are substantially parallel and the upper and lower bar are substantially parallel.

10. The rotary massaging system of claim 7 further comprising:
an inner and outer bar;
an upper and lower bar, wherein the inner, outer, upper and lower bar are hingedly connected;
a spring having a first and second end, wherein the first end is fixed relative to the hinged connection of the lower bar and the inner bar;
a cable having a first and second end, wherein the first end of the cable is attached to the second end of the spring;
a pulley, wherein the cable changes direction at the pulley;
wherein the second end of the cable is attached to the upper bar at a point between the inner bar and the outer bar;
a first gear fixed to the lower bar;
a second gear fixed to a lower portion of the frame;
wherein the second gear engages the first gear when the carriage mechanism is in a position near the lower portion of the frame;
wherein the engagement of the first and second gear causes the outer bar to move in an inward direction as the carriage mechanism moves closer to the lower portion of the frame.

11. The rotary massaging system of claim 7 further comprising:
an inner and outer bar;
an upper and lower bar, wherein the inner, outer, upper and lower bar are hingedly connected;
a spring having a first and second end, wherein the first end is fixed relative to the hinged connection of the lower bar and the inner bar;
a cable having a first and second end, wherein the first end of the cable is attached to the second end of the spring;
a pulley, wherein the cable changes direction at the pulley;
wherein the second end of the cable is attached to the upper bar at a point between the inner bar and the outer bar.
a lever having a first end, an intermediate point, and a second end, wherein the pulley is attached to the first end of the lever and the intermediate point of the lever is rotably attached to the inner bar;
a force adjustment actuator; and
a force adjustment tension cable having a first and second end, wherein the first end of the force adjustment tension cable is attached to the second end of the lever and the second end of the force adjustment tension cable is in operative communication with the force adjustment actuator.

12. The rotary massaging system of claim 1:
wherein the carriage mechanism is slideably engaged with a right portion and a left portion of the rectangular frame;
wherein the left and right portions of the rectangular frame are hingedly connected to an upper portion of the rectangular frame; and further comprising
a spring having a first end attached to a bottom portion of the rectangular frame, wherein the spring exerts a force on the bottom portion of the rectangular frame in the inward direction;
a first and second in and out guide rail, wherein the carriage mechanism is slideably engaged with said first and second in and out guide rail;
wherein the first and second in and out guide rails comprise a straight portion and a depressed portion; and
wherein the position of the carriage mechanism is inward when the carriage mechanism is engaged with the depressed portion relative to the position of the carriage mechanism when the carriage mechanism is engaged with the straight portion.

13. A seat for a vehicle comprising:
a seat back frame;
a sheet of flexible seat support material stretched across the seat back frame;
a rotary massaging system as claimed in claim 1 disposed within the seat back frame behind the sheet of flexible seat support material.

14. The seat for a vehicle of claim 13 further comprising a lumbar support apparatus attached to the seat back frame disposed between the sheet of flexible support material and the rotary massaging system.

15. The seat for a vehicle of claim 13 further comprising:
a lumbar support apparatus attached to the seat back frame disposed between the sheet of flexible support material and the rotary massaging system wherein the lumbar support apparatus is a belt-type lumbar support.
